(19) United States
(12) Patent Application Publication
(10) Pub. No.: US 2006/0031421 A1
(43) Pub. Date: Feb. 9, 2006

(54) Local community wireless network system utilizing multimedia receiver system

(76) Inventor: Toshio Hayakawa, Los Angeles, CA (US)

Correspondence Address: LINER YANKELEVITZ SUNSHINE AND REGENSTREIF, 1100 GLENDON AVENUE, 14TH FLOOR, LOS ANGELES, CA, 90024, US

(21) Appl. No.: 11/203,368

(22) Filed: Aug. 12, 2005

Related U.S. Application Data
(63) Continuation-in-part of application No. 10/357,552, filed on Feb. 4, 2003.
Application No. 10/357,552 is a continuation-in-part of application No. 10/100,643, filed on Mar. 19, 2002.
(60) Provisional application No. 60/345,926, filed on Dec. 31, 2001.

(51) Int. Cl. G06F 15/16

(52) U.S. Cl. 709/219

(57) ABSTRACT

A local community Internet service is provided through use of specialized hardware that allows a local provider to securely deliver unique community oriented services. The services that are provided include commercial services such as sales and special events at local retailers as well as telephone book-like services. Special services such as parent-teacher communication and health and vital signs monitoring can also be provided. Advertising and similar commercially derived revenue underwrites the cost of the service so that it can be provided at no cost or at a nominal cost.

### RELATED APPLICATIONS

This application claims priority from and is a continuation-in-part of my co-pending U.S. Utility application Ser. No. 10/357,552, filed Feb. 4, 2003 titled “Multimedia System Using Plasma or Liquid Crystal Display, Display System of Portable Computer, and Signal Receiver for Television, Radio, and Cellular Telephone” which in turn claimed priority from and is a continuation-in-part of my co-pending U.S. utility patent application Ser. No. 10/100,643, filed Mar. 19, 2002 titled “Multimedia Display System Using Display Unit of Portable Computer, and Signal Receiver for Television, Radio, and Cellular Telephone” which is, in turn, claims priority from U.S. provisional patent application Ser. No. 60/345,926 filed on Dec. 31, 2001; all of the foregoing applications are incorporated herein by reference.

### BACKGROUND

1. Field of the Invention

This invention relates to an implementation of local community network service utilizing a multimedia receiver system and connected components.

2. Description of the Prior Art

There are many social benefits to use of a local community network system. By network I am referring to any wide ranging public network (the Internet is the most widely adopted example of such a network and is used interchangeably with network herein) that can be used for information transfer between personal computers and other digital devices including digital cellular telephones and PDAs (personal digital assistants). In the context of “local community” such a network takes over the transmission of local information that is essential for the physical and economic health and welfare of the local community. Because the Internet and similar networks are capable of transmission of essentially any data from essentially any location, the exact boundary of the “community” is necessarily somewhat elastic. Perhaps it is best to visualize “local” as a set of nested features or services. For example, a local community Internet (network) can provide information about functions of public interest. Events and presentations at all of the local and regional museums would be of “local” interest. Meeting of the local town council would also be of “local” interest but in this case “local” is more restricted than the museum situation. Finally, meeting of the neighborhood association would also be of “local” interest but here local is an even more restricted in geographic area. One use of a local community network is to transmit data related to education. In the simplest case the network might inform parents of local school closings or of parent-teacher conferences, etc. However, a working network can do much more and can be used to transmit lessons and thus form part of the educational experience. With such a capability teachers located remotely (say at famous universities) can impart their knowledge to the local student body. Thus, the notion of “local community” can be expanded beyond the local school system.

While the potential benefits of a local community Internet are many, there have been a number of problems in implementing even the “regular” Internet. At this time around 60% of the U.S. population has Internet access. People are spending an increasing amount of time using the Internet, but computer and related technical problems and socioeconomic factors prevent maximal utilization. Users in the lower income groups may not own adequate computers and related systems. Further, lower income uses may not have access to optimal connections (i.e., bandwidth) to the network.

Many potential uses of the Internet depend on “bandwidth” so that “broadband” connections may be necessary. Unfortunately, the technology for broadband connection is in flux. One of the earliest modes of broadband connection was by means of digital television cables normally used to provide television service. More recently telephone companies have been providing broadband connections through digital subscriber lines (DSL). Unfortunately, both of these services may not be available to lower income and rural users. Cable systems may be slow to upgrade intercity neighborhoods to modern digital networks. In addition, cable Internet access may be prohibitively priced. Similarly, telephone service to intercity neighborhoods may not provide adequate DSL service. Further, because DSL users must be quite close to the central telephone switch, DSL is not available in remote rural areas. Therefore, in many cases the users who could most benefit form community-based Internet are unable to access the service.

In my earlier related applications I disclosed the use of a specialized multimedia receiver system module (MRS) that could link personal computers with cellular telephones to provide a variety of enhanced services using devices already in the possession of most consumers. With the present invention I disclose how the MRS can be extended to provide the full advantages of local community Internet. In the prior art there have been dedicated systems for Internet access (e.g., Web-TV or MSN-TV) by means of a television but such devices do not provide the features of the present invention. In addition, the present invention includes a business model for covering the cost of local community Internet access.

Objects

Accordingly, some of the objects and advantages of the present invention are presented below:

(a) to define and establish a commercially viable local community Internet (network) system;

(b) to provide simple and affordable hardware to access such a local community Internet system;

(c) to provide a number of special local community Internet services based on the simple and affordable hardware; and

(d) to provide a financial model to underwrite the local community Internet service.

These and further objects and advantages will be apparent to those skilled in the art in conjunction with drawings and the detailed description of the preferred embodiment set from below.

### SUMMARY OF THE INVENTION

In the present invention a multimedia receiver system (MRS) which is a specialized and dedicated computer system is used in place of a PC to access the Internet as well as a special “local community Internet.” The MRS contains a processor with supporting memory (RAM/ROM) and long-term data storage (e.g., a hard disc drive or other similar storage device) as well as input and output (I/O) circuitry. The MRS contains dedicated software that presents only a web browser interface to the user. The MRS is provided with standard video connectors to attach to a modern television set 30 for browser display. The MRS can be controlled by a typical mouse-keyboard combination which is preferably linked to the MRS wirelessly using Bluetooth or a similar short-range radio wave standard to avoid a confusing tangle of cables. Preferably the MRS connects wirelessly to the overall network although traditional “wired” connections can also be used.

When the system is activated, a web browser screen appears on the display. The URL displayed is that of the source company (SC) that provides the MRS and provides the local community-based Internet services. The MRS-SC business model is somewhat similar to the “free” internet service provider (ISP) model where the service is provided without cost in return for the user viewing advertisements. Like a free ISP the SC is able to provide customized and focused advertisements to its users in return for access to the local community Internet as well as the other services more typical of an ISP (e.g., world wide web and email). The SC also maintains the community-based Internet, which provides unique revenue potentials. Local merchants such as supermarkets and department stores are able to purchase access to the system so that the MRS can show all the local specials as well as current inventory of the local merchants to the user. This service replaces fliers and other similar resource wasting advertising material that is increasingly falling into disfavor. Further, the local community Internet provides specialized search engines that will search local merchants for prices and availability as well as discovering all sorts of local information rather like a super smart “yellow pages.” The local community Internet also provides the services that used to be provided by local community newspapers, which are now extinct in many communities. Thus, the SC garners the advertising revenues that formerly went to newspapers.

The SC and the local community Internet are financed, at least in part, by advertising revenues generated from the unique “flier” services it provides to local merchants. For example, a store wishing to advertise a particular special would purchase access from the SC instead of purchasing ad space in a newspaper or in the broadcast media. The local community Internet provide advertisers with an unparalleled ability to focus their ads; for example on extremely focused geographical lines or in response to demographic factors. In addition many of the other informational aspects of the system (such as local school communication functions) may prove so compelling that public entities such as public schools may contract with SC to ensure specific features and coverage. Where low income elderly or handicapped individuals are served, public funding will be involved.

These various revenue sources will allow the SC to provide free access to the users. The MRS can be provided free or at a subsidized price by the SC. Since the SC is able to charge the commercial users based on the number of network users available to receive advertisements, there is a strong motivation for the SC to provide no cost and/or extremely low cost access. By providing the MRS free or at a subsidized price, the SC would encourage use of the local community Internet. Because the MRS is a simplified, dedicated computer system, its actual cost will be fairly low. Once the MRS is widely installed, the local community Internet will become an indispensable service akin to the telephone.

### BRIEF DESCRIPTION OF THE FIGURES

FIG. 1 is a block diagram of a multimedia receiver system of the present invention.

FIG. 2 is a diagram showing the overall local structure of the local community Internet provided according to the present invention.

FIG. 3 is a diagram illustrating the nested nature of the content zones of the inventive local community Internet.

### DETAILED DESCRIPTION OF THE PREFERRED EMBODIMENT

It is the goal of the present invention to provide full benefits of local community-based Internet to users of essentially any socioeconomic level. The invention provides both hardware solutions to allow such access and a business model that makes the access universally affordable.

The “traditional” mode of accessing the Internet is by means of a desktop or portable personal computer system (PC). Although many households have such hardware, increasing problems with computer viruses and spyware have made many of such systems increasingly difficult or dangerous to use. This is particularly true in the case of the elderly users who may be able to afford a computer system but are unable to keep it operating without a great deal of expert assistance.

A typical PC consists of a display system (CRT or LCD), a processor (microprocessor, memory and software) and an input system (keyboard and mouse). The PC connects to the Internet by means of a “modem” that connects the processor to a digital cable, DSL line or other link to the Internet.

Although not all households have a PC, virtually all households have one or more television sets. Modern television sets have multiple inputs to connect cable, DVD players, VHS players, etc. Therefore, such a multiple input television can easily act as the display system for a specialized Internet access device. Although not all households have digital cable or DSL access, virtually all households have one or more cellular telephones. Today even relatively remote rural locations have cellular telephone service. Modern cellular telephones are digital and provide ideal gateways to digital networks such as the Internet.

Local Community Internet Access

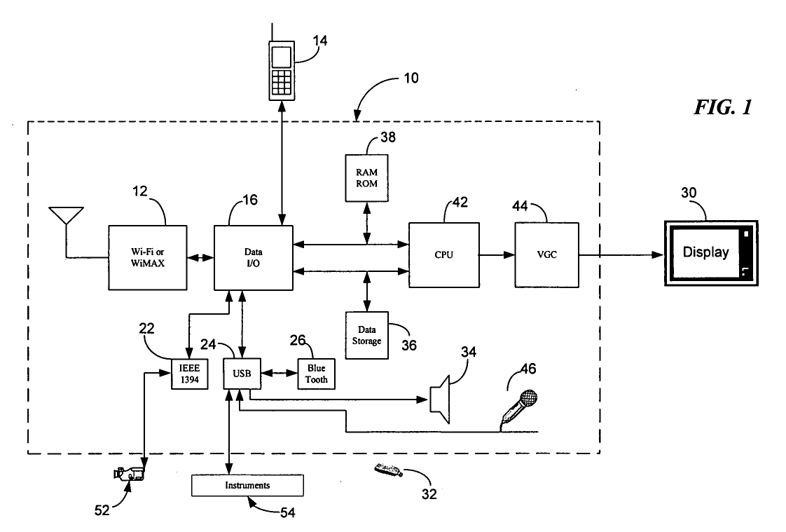

In the present invention the PC is replaced by an MRS which is a specialized and dedicated computer system. FIG. 1 shows a block diagram of the MRS 10 with a number of peripherals. The dashed line shows the components included within the MRS 10. The MRS 10 contains a processor 42 with supporting memory (RAM/ROM) 38 and long-term data storage 36 (e.g., a hard disc drive, flash RAM or other similar non-volatile storage device) and input and output circuitry 16. The MRS 10 contains dedicated software that presents only a web browser visual interface to the user. The MRS is provided with standard video connectors to attach to a modern television set 30 to a graphics controller 44 which is linked to the processor 42. When the MRS 10 is activated, the browser will appear on the screen of the television 30. All interaction is done through the browser so that the user does not need to own or learn to operate complex software.

The unit has standard I/O circuitry for connection of a limited range of digital devices. USB 2.0 (or a similar universal serial connection) 24 is preferred although an I.E.E.E. 1394 (FireWire) interface 22 may also be provided for certain applications such as video cameras 52 (see below). The MRS 10 can be controlled by a typical mouse-keyboard combination 32 although an alternate version working by recognizing the user's handwriting on a graphics tablet can be made available for users not familiar with a keyboard. The keyboard-mouse combination 32 is preferably linked to the MRS wirelessly using BlueTooth 26 or a similar short-range radio wave standard. Sound output 34 is standard, and sound input 46 is usually also provided. Other optional peripherals such a printers can also be linked by means of BlueTooth. This type of connection is preferred because one purpose of the MRS is to serve non-computer-savvy users who tend to be intimidated by a tangle of cables. Nevertheless, a variety of additional devices can be attached to the MSR by means of USB 24 or I.E.E.E. 1394 22. The MRS is also connected to the Internet or some similar data network through the data I/O circuitry 16.

The minimum MRS system consists of a display 30, an MRS unit 10 and an input (e.g., keyboard-mouse) 32. As explained above, the display 30 is normally a television set although an MRS can also be attached to a dedicated monitor such as one typically used with PC systems. When the unit 10 is activated, a web browser screen appears on the display. The URL displayed is that of the source company (SC) that provides the MRS and provides the local community-based Internet services. The SC is somewhat different than a typical internet service provider (ISP). A typical ISP provides access to the World Wide Web (www) of the Internet and also provides email service including email addresses to the end user. An ISP may also provide web page services and even e-commerce solutions. The most common ISP business model is a fee for service model although some ISPs provide free access to the World Wide Web and email in return for displaying advertisements as part of the package. That is, the free ISP system works somewhat like broadcast television where commercials pay for the programs. In some cases an ISP may know details of customer demographics; this allows the ISP to furnish customized and focused advertising to each customer.

Local Community Internet Implementation and Model

The MRS-SC business model is in some ways similar to the “free” ISP model. Like the free ISP the SC is able to provide customized and focused advertisements to its users in return for access to the local community Internet as well as the other services more typical of an ISP (e.g., World Wide Web access and email). However, the SC also maintains the community-based Internet, which provides unique revenue potentials. The SC delivers a variety of local interest public service web pages, not unlike community access cable television. Qualified public and non-profit entities are able to access SC's servers by means of the Internet to constantly update public information and make specialized announcements. Local merchants such as supermarkets and department stores are able to purchase access to the system so that the MRS can show the user the local specials as well as actual real time current inventory of the local merchants (by a link to the merchants point of sale and inventory system). This service replaces fliers and other similar polluting advertising that is increasingly falling into disfavor. The user can check in advance to make certain the merchant has a particular product in stock. It is also possible for consumers who have attached a printer to their MRS to print bar-coded coupons for use at the local merchants. Further, the local community Internet provides specialized search engines that will search local merchants for prices and availability as well as discovering all sorts of local information rather like a super smart “yellow pages.” Like the traditional “yellow pages” this aspect of the local community Internet can serve as a significant revenue source. The SC also provides the services that used to be provided by local community newspapers which are now extinct in most communities. By providing a local advertising venue for merchants and service provides the SC garners the advertising revenues that formerly went to newspapers.

The heart of the local community Internet is the combination of the SC and the MRS. Although it is possible for the MRS to be replaced by an ordinary PC, an ordinary PC would continue to be subject to viruses and software difficulties that many users find daunting. It would be entirely up to the SC as to whether an ordinary PC would be allowed to access some of the features of the local community Internet. The general parameters of the MRS have already been explained with the exception of data communication between the MRS and the SC. While any of the ordinary data communication methods common with the Internet (cable, DSL and ordinary telephone, to name a few) could be used with the MRS (and may be used in some situations), the preferred data communication pathway is wireless. Currently, the technology best suited is any of the so called “Wi-Fi” or “WiMAX” wireless broadband technologies such as I.E.E.E. 802.16 and/or cellular telephone data transmission and/or satellite data transmission. A potential drawback to the satellite route is the need for a specialized antenna, but in some rural situations, satellite may be the best choice. In most locations good cellular telephone service is available, and a variety of digital data transmission schemes are available with cellular systems (such as General Packet Radio Service and Enhanced Data for GSM Evolution, to name a few). The MRS contains a transceiver circuit (or a cell phone with such a circuit) capable of communication by means of one of the appropriate wireless formats. Currently, the wireless broadband technologies provide a higher data rate than cellular telephone transmissions but are not as widely available. All of this is subject to rapid change. The current versions of IEEE 802.16 provide wireless broadband coverage over distances of 40 miles or more. It is likely that some type of wireless broadband will become more widespread-perhaps being transmitted by most or all cellular telephone transmitters. At the same time cellular telephone data bandwidth is likely to increase rapidly. It is probable that wireless broadband and cellular transmissions will converge into a single system. While it is possible to embed a cellular telephone function within the MRS, it is probably more economical to simply provide a connector whereby a user simply attaches his or her cellular telephone prior to accessing the MRS. An advantage of this approach is that the MRS communication system is automatically updated every time an improved cellular telephone model becomes available. Also, this provides an opportunity to use some of the airtime minutes that many cellular telephone users are now “banking” with their phone service providers.

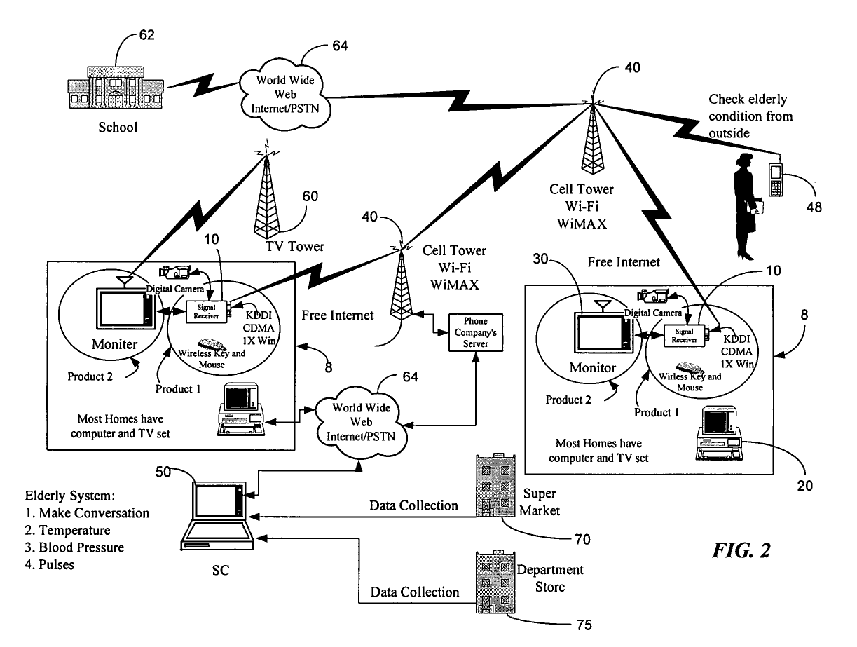

Referring to FIG. 2 the general layout of the local community Internet of the present invention. The boxes 8 represent the inside of a users home with the equipment usually found therein. Many homes contain a PC 20 and a television 30. The PC 20 is usually linked to the www 64. The MRS 10 is provided to communicate wirelessly with the www 64. This communication is provided by Wi-Fi 12 (FIG. 1) or by a cellular telephone 14 (FIG. 1). The cellular or wireless broadband signals are broadcast by towers 40 which are in communication with the www 64. Similarly, the television 30 used as a display by the MRS 10 can also receive data from a TV tower 60. The local community Internet resides in the servers of the SC 50 which receive data from a super market 70 and a department store 75. The local community Internet provides services for the school 62 and also provides phone warnings to cell phone 48 as well as ordinary wired telephones.

The SC and the local community Internet are financed, at least in part, by advertising revenues generated from the unique “flier” services it provides to local merchants. In the simplest sense a store wishing to advertise a particular special would purchase access from the SC instead of purchasing ad space in a newspaper or in the broadcast media. Like a newspaper or fliers the SC can guarantee focused coverage (see Local Community Internet Content, below). The nested nature of the zones within the local community Internet provide advertisers with an unparalleled ability to focus their ads. In addition, many of the other informational aspects of the system (such as the local school functions) may prove so compelling that public entities such as public schools may contract with SC to ensure specific features and coverage. Specialized features such as medical monitoring can be a fee for service activity where the costs are covered by the users. Where low income elderly or handicapped individuals are served, public funding will be involved.

These various revenue sources will allow the SC to provide free access or greatly subsidized to the users. The MRS can be provided free or at a subsidized price by the SC. Because the MRS is a simplified, dedicated computer system, its actual cost should be fairly low. Presently, there are entry level computer systems for only a few hundred dollars that are more than sufficiently powerful for this purpose. It seems likely that the real cost of the MRS could be held below about $300.00. By providing the MRS free or at a subsidized price, the SC would encourage use of the local community Internet. Once the MRS is widely installed, the local community Internet will become an indispensable service akin to the telephone. It should also be appreciated that once the system is functioning it can also provide typical broadband features (pay per view films, etc.) which can also serve as a revenue source.

Local Community Internet Content

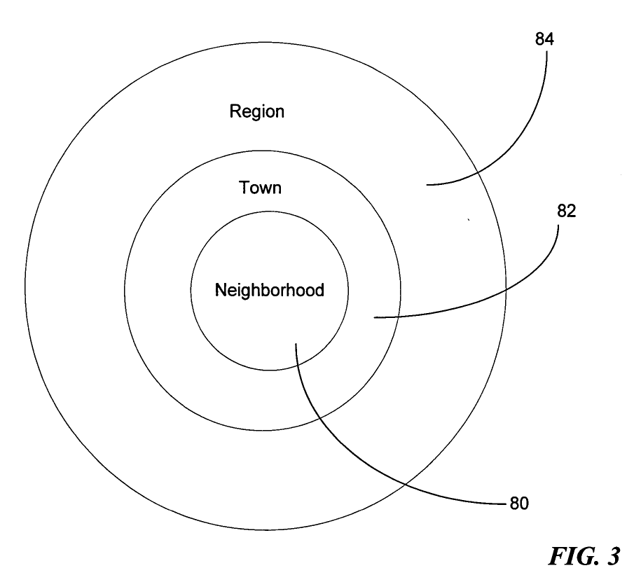

A key to the SC-local community Internet model is the way that the SC coordinates the local community-based Internet to fit the actual physical location of the users. As previously explained, the local community Internet can be viewed as sets of geographically related sites that cover a series of nested geographical areas ranging from regional to extremely local (e.g., the immediate neighborhood). The SC provides the MRS and the service and is aware of the precise geographical location of each user. Because the MRS directs all Internet access through the SC site, the SC servers are able to provide a customized array of local community Internet sites that coincides with the user's actual geographical location. Take the Los Angeles basin as an example. All users within the greater Los Angeles region would be presented with regional sites showing regional events and culture sites (museums, etc.). Users on the “west side” of Los Angeles would also be presented with events and commercial activities located in their area. Similarly, users in the San Fernando Valley would be presented with “valley” events and activities. Moving in to an even more local level, users in Santa Monica would be presented with Santa Monica events and commercial activities while users in the adjacent community of Venice would view a slightly different set of activities and events. At an even more local level a user would be provided with contact to local schools and government. A local corner store would provide local advertisement akin to the flyers that delivered to each local household. This concept is illustrated diagrammatically in FIG. 3 where the nested boundaries of the local community internet are illustrated to one particular location. The local neighborhood 80 forms the center of the diagram and includes information and advertisements, etc. for stores and facilities within a limited geographical radius of the user. The exact radius is probably less than about one quarter of a mile but can vary considerably from place to place. It will be apparent to one of skill in the art that the radius will be smaller in neighborhoods having great density and larger in sparse rural areas. A town zone 82 occupies a larger area in the example and would contain town-wide features such as local government and school district features. Finally, a regional zone 84 covers the largest area and includes regional features such as large parks, major retailers and cultural venues. Thus, FIG. 3 shows that a particular user would be able to access a series of nested community internet sites and features. It is important to appreciate that a second user located some distant from the first user might receive a different neighborhood 80 community Internet while being able to access the same town zone 82 and region zone 84 as the first user.

The local community Internet is also configured to provide a number of more specialized services not common or even present on the ordinary Internet. At one level the system provides specialized local email functions. A good example would be parent-teacher communications. The SC maintains special school related web pages. These pages are related only to the school(s) attended by children of a user and can be accessed only by the parents to send messages to the teachers or administrators and by school personnel to talk to the parents. This allows real time monitoring of student performance. When a student has not been doing his or her homework, the parents and teacher can exchange messages nightly to verify homework compliance. Similar local communication is available with city government and other local government and utility services. It will be appreciated that these services fall within either the neighborhood zone 80 or the town zone 82. The localized nature of the service avoids the possibility of spam.

More specialized community services are also available. As explained in reference to FIG. 1, the MRS contains inputs for the transmission of video and instrument data. One important use of this capability is for monitoring the elderly or the convalescent. The MRS can transmit real time data from medical monitors such as heart rate, blood pressure and body temperature. The video input can transmit real time images of a bed ridden individual. This information can be used to enable the elderly to live alone as long as possible. While assisted living or hospitalization may eventually become inevitable, such care is extremely expensive and every effort must be made to postpone this type of care as long as possible. Children or medical personnel at a remote location can readily monitor individuals at risk and receive an alarm if conditions change. Now that most Internet functions can be readily accessed from cellular telephones, medical status can be checked from cellular phones and automatic alarms can be sent to phones. While this type of specialized service can be viewed as existing in the neighborhood zone 80 from the standpoint of the individual being monitored, the medical personnel and the children may physically be located within the wider zones pictured in FIG. 3 and/or any other location accessible by Internet. That is, while the focus of the local community Internet is on truly local matters, it can also interact with the rest of the global Internet.

Local Community Internet Software

All of the local community Internet information is presented through a graphical web browser interface. Therefore, the users do not need to understand anything about a computer. There are no computer files and no programs to run or install with the exception of the web browser the software is hidden from the user. The real advantage is that all the functionality is provided by html/xml web pages, cgi (Common Gateway Interface) scripts and web-related applications such Java and Javascript. Most of the functionality can be provided by web designers and web programmers with little or no complex custom programming. Many commercial vendors who wish to use the service will already have extensive web presence. Code from existing web sites can be easily modified and moved to the SC's servers. This includes the use of web based use of databases (SQL, MySQL, WebObjects, etc.)

The MRS can be implemented with reliable and inexpensive Open Source software. For example, the processor 42 can execute a reliable, virus-resistant UNIX variant such as Linux. The operating system would handle all of the I/O functions but would not be accessible to the users. Other operating systems are also useable. The operating system executes only a single user program-a special version of web browser which is “hard wired” to display only a special SC web page. The SC web page recognizes the user's identity and acts as a gateway to provide access only to the appropriate local community Internet sites as well as to other Internet and email services. The connection to the WWW is made through the SC so that the local community Internet is hidden behind and protected by the SC's firewalls. To further protect the users the communication with the SC web page can occur by means of SSL (secure socket layer) or a similar safe technology. The MRS is designed to be left in operation continuously (it transitions into a power-saving “sleep mode” when not in use). The SC is able to access the MRS to update the software as required. Because no user information or data is stored on the MRS (all user data is stored on the SC's servers), even if the MRS experiences a catastrophic failure or is stolen, no user information is lost or compromised.

The following claims are thus to be understood to include what is specifically illustrated and described above, what is conceptually equivalent, what can be obviously substituted and also what incorporates the essential elements of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A system for providing wireless local community network access comprising:
a multimedia receiver system;
a local community network server in data communication with the worldwide Internet; and
at least one wireless data transceiver to place the multimedia receiver system in data communication with the local community network server so that the multimedia receiver system can access local community content on the local community network server.

2. The system according to claim 1, wherein the multimedia receiver system access the Internet through the local community network server.

3. The system according to claim 1, wherein the wireless data transceiver provides a secure communication channel is established between the local community network server and the multimedia receiver system

4. The system according to claim 1, wherein the local community network content is arranged in concentric zones with each zone containing content having a geographic relationship and wherein the concentric zone related to a most restricted geographic region can be accessed only by a multimedia receiver system physically located within that same most restricted geographic region.

5. The system according to claim 1, wherein the multimedia receiver system additionally comprises inputs for special data and the special data are transmitted from the multimedia receiver to the local community network server.

6. The system according to claim 5, wherein the special data are selected from the group consisting of video data, audio data and instrument data.

7. The system according to claim 6, wherein the instrument data comprise medical data.

8. The system according to claim 1 further comprising means for automatically generating and transmitting warning messages in response to the special data.

9. The system according to claim 8, wherein the warning messages are transmitted over the Internet as email and/or to telephones as voice messages or as text messages.

10. The system according to claim 1, wherein the local community content comprises advertisement pages from local commercial sponsors and public interest pages from local government and non-profit agencies.

11. The system according to claim 10, wherein the local commercial sponsors pay a fee to the local community network server to provide the local community content advertisement pages.

12. The system according to claim 10, wherein one of the local commercial sponsors is able to control the content of its advertisement page according to the geographic location of the multimedia receiver system accessing the advertisement page.

13. A method for providing wireless local community network access comprising the steps of:
providing a local community network server in data communication with the worldwide Internet;
establishing local community network pages on the local community network server;
charging fees to place content on the local community network pages
providing multimedia receiver systems to end users wherein cost of the multimedia receiver systems and their use is at least partially underwritten by the fees to place content on the local community network pages; and
providing at least one wireless data transceiver to place the multimedia receiver systems in data communication with the local community network server so that the multimedia receiver system can access local community network pages on the local community network server.

14. The method according to claim 13, wherein the local community network pages are arranged in concentric zones with each zone containing pages with content having a geographic relationship and wherein the concentric zone related to a most restricted geographic region can be accessed only by a multimedia receiver system physically located within that same most restricted geographic region.

15. The method according to claim 13, wherein the multimedia receiver system additionally comprises inputs for special data and the special data are transmitted from the multimedia receiver to the local community Internet server.

16. The method according to claim 15, wherein the special data are selected from the group consisting of video data, audio data and instrument data.

17. The method according to claim 16, wherein the instrument data comprise medical data.

18. The method according to claim 15 further comprising means for automatically generating and transmitting warning messages in response to the special data.

19. The method according to claim 18, wherein the warning messages are transmitted over the Internet as email and/or to telephones as voice messages or as text messages.

20. The method according to claim 13, wherein the local community content comprises advertisement pages from local commercial sponsors and public interest pages from local government and non-profit agencies.

21. The method according to claim 20, wherein the local commercial sponsors pay fees to the local community Internet server to provide the local community content advertisement pages.

22. The method according to claim 20, wherein one of the local commercial sponsors is able to control the content of its advertisement page according to the geographic location of the multimedia receiver system accessing the advertisement page.
